(19) United States
(12) Patent Application Publication
(10) Pub. No.: US 2023/0294551 A1
(43) Pub. Date: Sep. 21, 2023

(54) Multi-Module Electric Vehicle Battery Control System

(71) Applicant: Ample Inc., San Francisco, CA (US)

(72) Inventors: Xin Zhao, San Francisco, CA (US); Khaled Hassounah, San Francisco, CA (US)

(21) Appl. No.: 17/655,444

(22) Filed: Mar. 18, 2022

(51) Int. Cl. B60L 58/13; B60L 58/20

(52) U.S. Cl. CPC B60L 58/13; B60L 58/20; B60L 2240/547; B60L 2240/549; B60L 2210/42

(57) ABSTRACT

A system and method for operating a multi-battery module electrical power system is disclosed. The system and method permit safe and efficient operation with multiple batteries of varying characteristics including in controlling and connecting said batteries to a bus or load such as a DC motor for one or two-directional current and power flow. In an aspect the present system comprises multi-layer controls that can controllably switch operation of the system or portions thereof between several (e.g., four) operating quadrants defined by a voltage-current characteristic.

### TECHNICAL FIELD

This application relates to the design and operation of electrical battery systems such as those found on electrically powered vehicles.

### BACKGROUND

A need exists for practical and safe electric battery systems. Typically, it is not possible or practical to couple multiple batteries in parallel where the batteries are of different ratings, chemistries, ages or have other compositional differences. Batteries of different nature, composition or service histories can have varying internal impedances and voltage outputs. In one respect, operating multiple but varied batteries together, e.g., in parallel, can result in unwanted electrical surges as well as degradation or damage to the batteries themselves and/or the loads and other connected components. Also, a need exists for improved battery controls in the context of electrically powered vehicles, whether the vehicles are land, sea, air or space based.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

One embodiment is directed to a system for powering an electric motor from a battery unit comprising a plurality of battery module units, the system comprising a plurality of battery module units, each having a battery module and a battery module controller circuit; an electric bus coupled to said electric motor; wherein each of said battery module controller circuits comprises a first side of said battery module controller circuit, electrically coupled to its respective battery module at a respective battery module voltage Vbatt, and a second side of said battery module controller circuit, electrically coupled to said electric bus by a bus side connection and at a bus voltage Vbus; and at least one switch within said battery module controller circuit that switches between multiple switching states; and wherein each battery module operates in a plurality of operating modes depending on the switching state of its respective battery module controller circuit, including: a first state in which a difference (Vbus−Vbatt) is greater than zero and a current on said bus is greater than zero; a second state in which the difference (Vbus−Vbatt) is greater than zero but the current on said bus is less than zero; a third state in which the difference (Vbus−Vbatt) is less than zero and the current on said bus is less than zero; and a fourth state in which the difference (Vbus−Vbatt) is less than zero while the current on said bus is greater than zero.

### BRIEF DESCRIPTION OF THE DRAWINGS

For a fuller understanding of the nature and advantages of the present concepts, reference is made to the detailed description of preferred embodiments and the accompanying drawings.

FIG. 1 illustrates a simplified arrangement of several battery modules in a system according to embodiments of the invention.

FIG. 2 describes a four-state or quadrant operational space showing each of four operating sets of conditions or states.

FIG. 3 illustrates an exemplary battery module controller circuit and main components of a bidirectional buck-boost converter.

FIG. 4 illustrates an equivalent circuit of the controller when operating in the quadrants Q1 or Q2.

FIG. 5 illustrates an equivalent circuit of the controller when operating in the quadrants Q3 or Q4.

FIG. 6 illustrates an embodiment of a battery module controller circuit.

### DETAILED DESCRIPTION

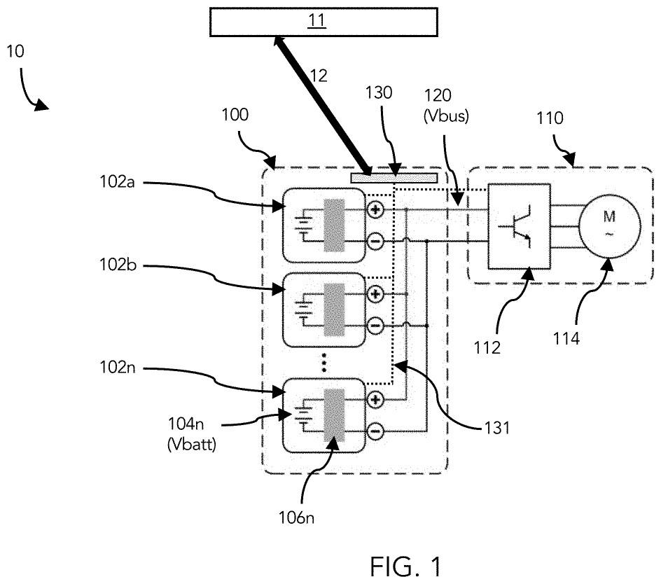

FIG. 1 illustrates a basic arrangement of several battery modules in a system 10 according to embodiments of the invention. A battery assembly 100 comprises a plurality (n) of battery module units 102a . . . 102n (generally 102). The battery module units 102 each comprise one or more battery modules 104a . . . 104n (generally 104) that can in turn comprise a plurality of battery cells therein, as well as a respective battery module controller circuit 106a . . . 106n (generally 106), to be described in more detail below. In general, the multi-modules referred to herein may have a reference numeral (e.g., 102, 104, 106, etc.) that is understood to correspond to a set of individual examples of the referenced numeral, one for each respective module in the multi-module system (so 102 can correspond to one or more of 102a, 102b, . . . 102n) without loss of generality and where the discussion applies to any or all of such elements. The accompanying drawings may thus show one instance (e.g., 102a or 102n) and this is not meant to limit or exclude reference to other similarly numbered referenced elements.

The battery assembly 100 is typically used to store electrical energy and/or to provide power on demand to an electrical load 110, for example an electrical load may comprise one or more electric motors such as DC motors for propelling an electric vehicle, or they may comprise house loads such as lighting, communications, and comfort loads in a vehicle with DC power bus requirements. The present system can be used in powering alternating current (AC) loads such as AC motors by delivering the bus power through a DC to AC converter to drive the AC load or motor.

A load controller 112 which may comprise a power regulator, transformer and/or converter may be employed to bring the bus voltage Vbus to a form that can be used to drive the load or motor 114. In some examples, e.g., if the motor 114 is an AC motor, the power regulator may comprise a DC to AC converter.

A master controller 130 is disposed at a layer above the battery module controller circuits 106 as well as to the load controller 112. The master controller 130 is coupled to each of the other controllers via a control bus 131 that can electrically couple these control units to one another and exchange control signals therebetween. Master controller 130 may comprise electrical and/or electronic circuitry including programmable units, one or more processors, and circuits configured and arranged to execute machine-readable instructions to manage and control the overall operations of the system 10 and battery assembly 100 or battery module controllers 106. Master controller 130 may be coupled over a CAN bus to said other components of system 10 within battery assembly 100, or to/from external systems and components. Master controller 130 can programmably set power limits (e.g., kilowatts) on the power delivered from battery assembly 100, or from a given battery module unit 102. In an aspect, master controller 130 may communicate over said CAN bus, through communication ports or connections to external diagnostic or monitoring systems and computers to ascertain the operational and performance or service status of system 10, to upload updated instruction sets thereto, or to control the system 10.

The present architecture can be useful in powering and controlling electrically driven vehicles such as electric cars, buses, trucks, trains and delivery vehicles, drones and other vessels as described. In particular, these systems and methods can be adapted for controlling the power delivery to and from multi-cell battery units having a plurality of swappable battery modules so that one or more battery modules can be physically removed from the vehicle while other battery modules are not removed from the vehicle, e.g., for charging or servicing the removed modules outside the body of the vehicle. The present system and method could therefore maintain and control the battery modules while inside the vehicle, in coordination with an architecture for servicing the battery modules if and when they are removed from the vehicle. So, a communication bus, including optionally wide area network communication connectivity can be established in optional embodiments to control and program and/or facilitate the features described herein. In an optional aspect, a service station 11 or data connected server controller establishes a data communication path 12 (including over the air between two compatible communication transceivers) to manage, monitor and control some or all operations of the onboard vehicle master controller 130.

Each battery module unit 102 can be described by a battery voltage Vbatt_i defining the electromotive force available from said (i_th) battery module 104. In one aspect, the several battery module units 102 voltages Vbatt_i may be the same or similar, but according to this invention, the managed system enables and supports different BM voltage levels while operating said plurality of BM 104 in parallel with one another as described herein. In another aspect, under the present system and method, V_batt may be but is not necessarily equal to the DC bus voltage Vbus 120. In this aspect, Vbatt_i is a terminal voltage of a battery module i, which is typically the voltage potential at the coupling port of a BM controller 106. The controllers 106i can be thought of as a layer which decouples the respective i_th battery from the DC bus 120.

Both energy storage and power delivery capabilities are considered in designing the present systems. Therefore, each battery module controller 106 of each respective battery module units 102 can control its individual performance within the context of master controller 130 settings, and including controlling the individual battery module bus currents Ibus_i of the (i_th) module as an example, which can be a positive or a negative current depending on whether the given battery module 104 is in a discharging or a charging mode of operation. Generally, electrical power (P) is proportional to the product of system voltage and the current in a DC system. If battery and DC bus power are represented as Pbatt and Pbus these are generally obtained using Vbatt*Ibatt or Vbus*Ibus in the present notation. The system 10 including the controllers thereof and/or master controller 130 can be used to control the battery module currents Ibatt_i of each (i_th) battery module.

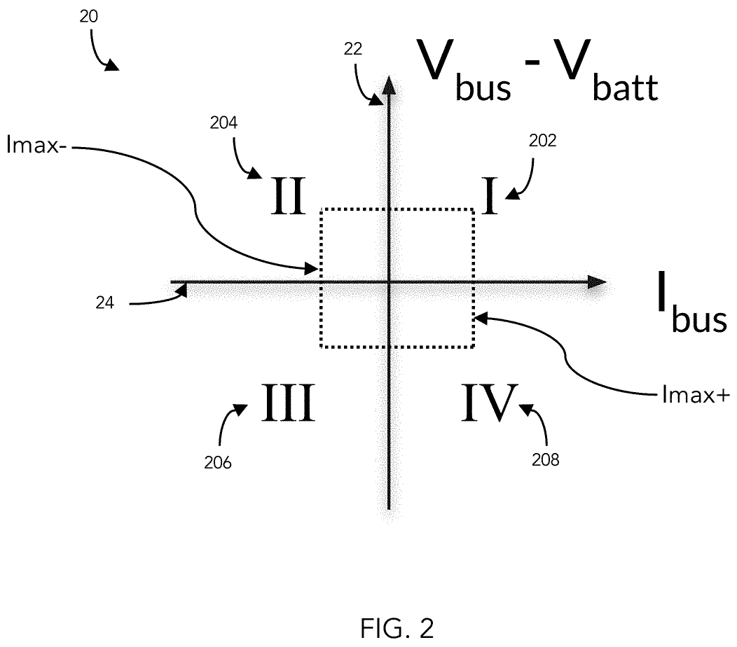

Aspects of the present battery module (BM) control layer include voltage control whereby the system and method are capable of managing voltage differences between the system battery modules and the load or vehicle's powertrain voltage, and current control whereby the system and method are capable of managing bidirectional current flow and enabling a sufficient current flow along the various circuit pathways of the system. We may define the voltage and current modes of operation according to their state on a four-quadrant scheme 20 as illustrated in FIG. 2 showing each of four operating sets of conditions, modes, or states. The difference between bus and battery voltage (Vbus−Vbatt) is defined on the vertical axis 22. The DC current flowing in or out on the main system bus is defined on the horizontal axis 24, e.g., positive or negative depending on the direction in said bidirectional flow when charging or discharging the batteries. Therefore, a first (I) operating quadrant 202 is identified for the states where Ibus>0 and Vbus−Vbatt>0; a second (II) operating quadrant 204 is identified for the states where Ibus<0 and Vbus−Vbatt>0; a third (III) operating quadrant 206 is identified for the states where Ibus<0 and Vbus−Vbatt<0; and a fourth (IV) operating quadrant 208 is identified for the states where Ibus>0 and Vbus−Vbatt<0.

The bus current Ibus is a sum of contributions from each battery module, e.g., Ibus_a+Ibus_b+ . . . +Ibus_n. The overall current (Ibus) from the batteries to the load can be greater or less than zero, depending on the net currents and directions thereof. The present battery systems are DC systems, which allow bi-directional movement of current within the system depending on its mode of operation. For example, the current may be defined to be a “positive” flow in one mode of operation (either charging or discharging) or a “negative” flow of current (discharging or charging, respectively the opposite). Therefore, examples provided herein are exemplary, and a current flow convention can be defined as desired in a given application, sometimes based on positive charge flow or in the alternative based on negative charge flow. Either convention would be covered by the present disclosure.

In an aspect, each battery module controller circuit 106i operates in one of four operating modes (or an operating quadrant) as described below, sharing a common parameter which is the bus voltage Vbus. The operating quadrants are aspects of a battery module control layer according an aspect of the invention. The operating mode and operating quadrant can be set for one or more of the battery modules such that they may controllably: deplete/use all of the battery modules at the same time or at the same rate; deplete some of the battery modules before others; or a hybrid of the two foregoing operations. Accordingly, the invention may in some aspects allow decoupling of a battery module from the electric vehicle's power train and/or from other battery modules in the battery assembly and system. This can provide a powerful smart battery architecture for any electric vehicle including various electric cars, trucks and other vehicles that are battery powered.

When generally in a battery charging mode, the system will charge a battery module by operating it in one of the second or third operating quadrants (204, 206). When generally in a discharging mode, the system will discharge a battery module by operating it in one of the first or fourth operating quadrants (202, 208). The switching of the operating states and quadrants is described below.

Operationally, a pulse width modulator and pulse width modulation scheme may be employed to drive the operating mode of the system between the four operating quadrants as described earlier. The duty cycle of the control circuit switching elements can be used to achieve this switching depending on the target operating state of interest as dictated by the master controller 130. For switch elements, the invention may employ transistors, diodes or other voltage and/or current controlled semiconductor devices to act as a gating or switching component. Other alternative or equivalent elements can be substituted by those skilled in the art upon review of the present disclosure without loss of generality.

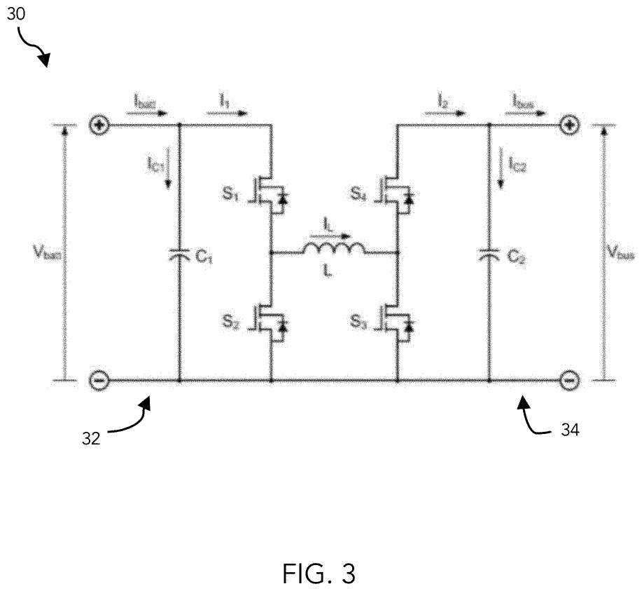

FIG. 3 illustrates an exemplary circuit 30 and main components of a bidirectional converter for controlling a multi-module battery system which may include battery modules of different architecture, chemistry, state of charge and electrical/chemical condition. In one example, the converter may comprise a buck-boost converter comprising a control circuit characterized by a half bridge on the battery side 32 characterized by battery voltage (Vatt), the inductor (L) and a second half bridge on the bus side 34 characterized by bus voltage (Vbus). The inductor L maintains current by storing energy in its magnetic field. Capacitors, e.g., C1, C2, maintain voltage by storing energy in an electrical field between the respective plates of said capacitors. Current in or out of the battery system is labeled as lbatt while current in or out of the bus is labeled Ibus. Voltage and current values throughout the circuit 30 obey the conventional rules for voltage and current summation (e.g., Kirchhoff's current law at any given circuit node) and the principles of electrical power flow in the capacitors and inductors.

The control circuit may comprise one or more active elements such as transistors, e.g. (MOSFET) elements S1, S2, S3, S4 that can controllably change the conduction path to pump charge between buffers in the circuit. In an embodiment, the transistors (S1, S2, S3, S4) are controllably switched by the battery module controller 106 of a corresponding battery module unit 102 and/or battery module 104. The speed or frequency or periodicity of switching can be adjusted as needed to achieve an operating state in one of the afore-mentioned four operating quadrants (controlling pulse width modulation).

The control circuit 30 is controlled with respect to its switching frequency. Various embodiments may employ so-called soft switching and/or multiphase interleaving. In an aspect, soft switching can improve the system's efficiency at the expense of circuit. In an aspect, multiphase interleaving can improve the circuit's power rating although this comes at added cost.

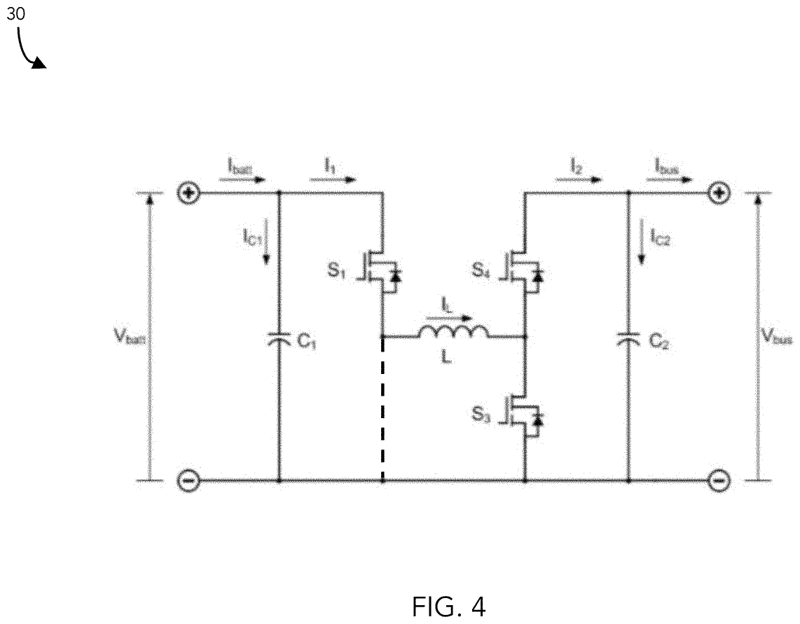

FIG. 4 illustrates the equivalent circuit of FIG. 3 when operating in the quadrants Q1 or Q2 and whereby transistor switch S2 is open and its leg of the circuit (shown as a dashed line) does not carry current.

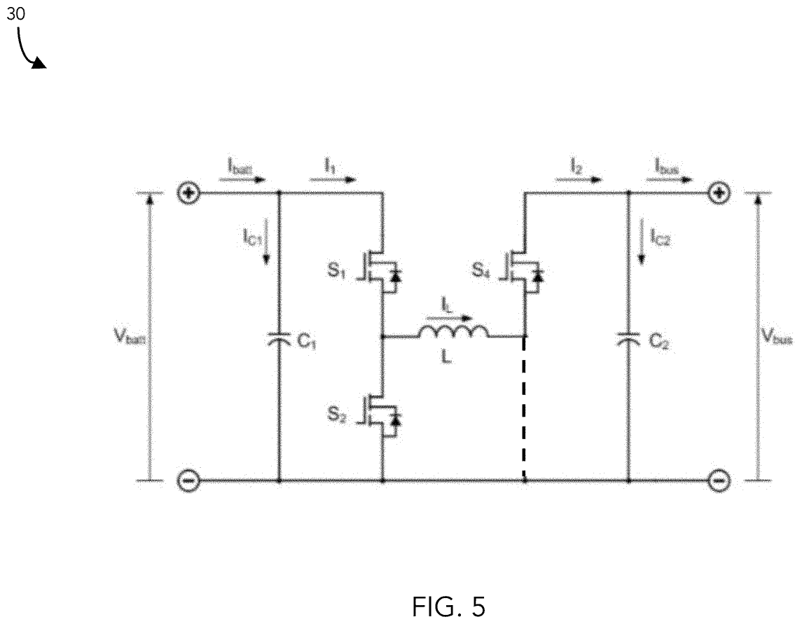

FIG. 5 illustrates the equivalent circuit of FIG. 3 when operating in the quadrants Q3 or Q4 and whereby transistor switch S3 is open and its leg of the circuit (shown as a dashed line) does not carry current.

Referring to FIGS. 3-5, when switch S3 is open (OFF) and switch S4 is closed (ON), the circuit operates as a synchronous buck converter. Using feedback control, the current can be controlled in a bi-directional way (greater or less than zero or reversing direction) with Vbatt>Vbus the circuit operates in the third or fourth quadrants (Q3 when charging or Q4 when discharging). On the other hand, when switch S2 is open (OFF) and switch S1 is closed (ON), the circuit operation is mirrored and current can be bi-directional with Vbatt<Vbus where the circuit operates in the first and second quadrants (Q1 or Q2).

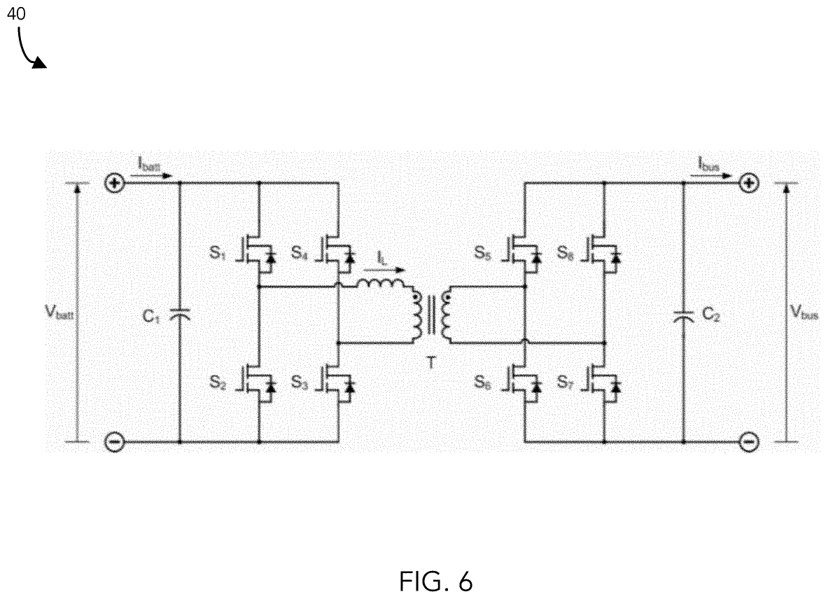

FIG. 6 illustrates an alternate exemplary embodiment of a control circuit 40 for use in the invention. The alternate embodiment comprises a bidirectional dual active bridge (DAB) converter in an example. The DAB comprises two full bridge circuit parts plus a connecting transformer T. A first full bridge is disposed on the battery side and coupled to the battery voltage Vbatt. The second full bridge is disposed on the bus side and coupled to the bus voltage Vbus. This design can provide galvanic isolation between the two sides of the circuit across the transformer. Design considerations of this embodiment may include the added size of the transformer T and the added cost of the additional transistor switches S. Those skilled in the art can implement a control circuit based on specific requirements of their application without departing from the scope of this invention, be it using the particular examples illustrated or equivalent and alternative circuit designs that achieve substantially the same results needed for their applications. For example, yet other implementations employing a resonant LLC converter or employing a Cuk converter may also be used.

In an aspect of the invention, the present system and method allow for different voltages between the battery modules and the load bus (for example a vehicle's powertrain) during operation. In another aspect, the present system and method allow for voltage differences between the various battery modules themselves. Therefore, the present system and method permit controllable decoupling of the battery modules and battery unit from the bus and/or load as needed, and for flexible operation under a number of conditions.

In yet another aspect, the present system and method allow for current scheduling among individual battery modules and other operating flexibility.

A notable result of using the present system and method is that several battery modules 104 of varying characteristics may be employed and coupled in parallel as shown without substantial performance or safety problems, on account of the present controllers and control systems including battery module controllers 106. In an aspect, the battery cells of the battery modules 104 may not each have the same inherent electromotive force capacity or voltage Vbatt. Specifically, the individual battery cells and battery modules of the several battery module units 102 may vary in their individual capacity, age, operating history, charge-discharge characteristics, chemistry, capacity, physical dimensions and other aspects. Such differences in battery design and operation will cause non-identical power performance, availability, and other variations in voltage and current characteristics. Without proper control and management of such multi-battery systems, differences in output voltage could cause internal and inter-unit voltage differences and unwanted currents, in the worst case manifesting as short circuit conditions when voltage differences are present on a common output bus. Consequences of such variations could, absent proper control and regulation, can be electrical and/or thermal in nature and may result in damage to electrical and electronic components, damaged battery cells, malfunctioning of overall power systems. Electrical current overloads in the batteries, battery modules or connected parts can in the worst-case scenario cause thermal runaway in conductors on account of Ohmic losses and/or dangerous energy or pressure buildup within a battery unit that can sometimes result in an explosion of the battery housing.

The present invention provides for flexible, efficient and safe power flow control in a multi battery module architecture. The present system and method can individually and controllably specify how much relative power is drawn from each battery module in a multi battery module system. In an aspect, this allows the battery modules to be controllably depleted, for example to be depleted at a same relative rate if the operator so requires.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will appreciate the many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments may be implemented in numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory, one or more data storage discs, optical discs, magnetic tapes, flash memories, circuit configurations in field programmable gate arrays or other semiconductor devices, or other tangible computer storage medium) encoded with one or more programs that, when executed on one or more computers or other processors, perform methods that implement one or more of the various embodiments described above.

Computer-executable instructions may be used to control one or more processors and circuits used with this invention and may be provided in many forms, such as program modules, executed by one or more computers or other devices. The functionality of the program modules may be combined or distributed as desired in various embodiments.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A system for powering an electric motor from a battery unit comprising a plurality of battery module units, the system comprising:
a plurality of battery module units, each having a battery module and a battery module controller circuit;
an electric bus coupled to said electric motor;
wherein each of said battery module controller circuits comprises:
a first side of said battery module controller circuit, electrically coupled to its respective battery module at a respective battery module voltage Vbatt, and a second side of said battery module controller circuit, electrically coupled to said electric bus by a bus side connection and at a bus voltage Vbus; and
at least one switch within said battery module controller circuit that switches between multiple switching states;
and
wherein each battery module operates in a plurality of operating modes depending on the switching state of its respective battery module controller circuit, including: a first state in which a difference (Vbus−Vbatt) is greater than zero and a current on said bus is greater than zero; a second state in which the difference (Vbus−Vbatt) is greater than zero but the current on said bus is less than zero; a third state in which the difference (Vbus−Vbatt) is less than zero and the current on said bus is less than zero; and a fourth state in which the difference (Vbus−Vbatt) is less than zero while the current on said bus is greater than zero.

2. The system of claim 1, wherein the battery modules each comprise a plurality of battery cells therein, at least some of said cells being connected in series with one another.

3. The system of claim 1, wherein each of said battery module control circuits comprises a two-sided design, each of said two sides being electrically coupled to one another by way of an inductor.

4. The system of claim 1, wherein each of said battery module control circuits comprises a two-sided design, each of said two sides being electrically coupled to one another by way of a transformer.

5. The system of claim 1, wherein said battery module controller circuits are each adapted to operate a respective battery module within a four-quadrant state space comprising said four states of operation.
